(19) United States
(12) Patent Application Publication
(10) Pub. No.: US 2021/0279664 A1
(43) Pub. Date: Sep. 9, 2021

(54) CONTROL APPARATUS, VEHICLE, NON-TRANSITORY COMPUTER READABLE MEDIUM, AND CONTROL METHOD

(71) Applicant: TOYOTA JIDOSHA KABUSHIKI KAISHA, Toyota-shi (JP)

(72) Inventors: Hiromitsu FUJII, Kariya-shi (JP); Kohei MIWA, Nisshin-shi (JP); Yuko MIZUNO, Nagoya-shi (JP); Shinsuke ARIGA, Nagoya-shi (JP); Hirotaka OMISHA, Nisshin-shi (JP); Tsuyoshi OKADA, Nagoya-shi (JP)

(73) Assignee: TOYOTA JIDOSHA KABUSHIKI KAISHA, Toyota-shi (JP)

(21) Appl. No.: 17/194,913

(22) Filed: Mar. 8, 2021

(30) Foreign Application Priority Data
Mar. 6, 2020 (JP) 2020-039293

(51) Int. Cl. G06Q 10/06; G06Q 10/02; G06Q 50/30; G08G 1/00; G01G 19/12

(52) U.S. Cl. CPC G06Q 10/06315; G06Q 10/02; G01G 19/12; G08G 1/202; G06Q 50/30

(57) ABSTRACT

A control apparatus for controlling a vehicle communicably connected to a user terminal, and including a controller. The controller is configured to: perform control to store, in the vehicle, baggage of a user of the user terminal; and perform control to deliver the baggage to the user in response to a request from the user terminal.

### CROSS-REFERENCE TO RELATED APPLICATION

This application claims priority to Japanese Patent Application No. 2020-039293 (filed on Mar. 6, 2020), the entire contents of which are incorporated herein by reference.

### TECHNICAL FIELD

The present disclosure relates to a control apparatus, a vehicle, a program, and a control method.

### BACKGROUND

Navigation apparatuses that propose a travel plan, provide route guidance when the proposed travel plan is selected by a driver, and receive a satisfaction rating from a user after completion of the route guidance are known (for example, Patent Literature [PTL] 1).

### CITATION LIST

### Patent Literature

PTL 1: JP 2009-258026 A

### SUMMARY

The navigation apparatus described above proposes a travel plan for a traveler, but does not execute a process that considers baggage of the traveler.

It would be helpful to provide a control apparatus, a vehicle, a program, and a control method, which can reduce the amount of baggage carried by the user while the user is moving.

A control apparatus according to an embodiment of the present disclosure is for controlling a vehicle that is communicably connected to a user terminal. The control apparatus includes a controller, wherein the controller is configured to:

perform control to store, in the vehicle, baggage of a user of the user terminal; and

perform control to deliver the baggage to the user in response to a request from the user terminal.

A program according to an embodiment of the present disclosure is configured to cause a computer as a control apparatus for controlling a vehicle that is communicably connected to a user terminal, to execute:

control to store, in the vehicle, baggage of a user of the user terminal; and

control to deliver the baggage to the user in response to a request from the user terminal.

A control method according to an embodiment of the present disclosure is performed by a control apparatus for controlling a vehicle that is communicably connected to a user terminal. The control method includes:

performing control to store, in the vehicle, baggage of a user of the user terminal; and

performing control to deliver the baggage to the user in response to a request from the user terminal.

The control apparatus, the vehicle, the program, and the control method according to embodiments of the present disclosure can reduce the amount of baggage carried by the user while the user is moving.

### BRIEF DESCRIPTION OF THE DRAWINGS

In the accompanying drawings:

FIG. 1 is a schematic diagram of an information processing system;

FIG. 2 is a block diagram illustrating a configuration of a control apparatus;

FIG. 3 is a block diagram illustrating a configuration of a vehicle;

FIG. 4 is a block diagram illustrating a configuration of a user terminal;

FIG. 5 is a diagram illustrating storing of baggage;

FIG. 6 is a diagram illustrating an example of a data structure of a baggage database (DB);

FIG. 7 is a diagram illustrating an example of a data structure of a schedule DB;

FIG. 8 is a diagram illustrating another example of a data structure of the baggage DB;

FIG. 9 is a diagram illustrating receiving of baggage, and;

FIG. 10 is a flow chart illustrating operation of the control apparatus.

### DETAILED DESCRIPTION

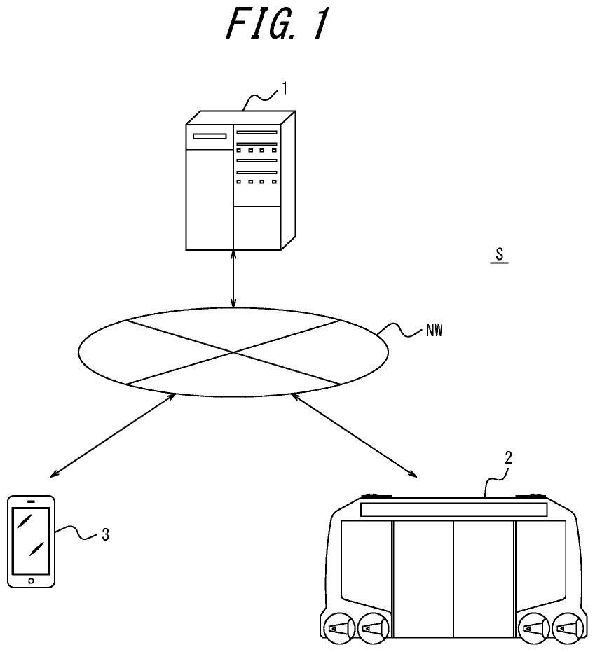

FIG. 1 is a schematic diagram of an information processing system S according to an embodiment. The information processing system S includes a control apparatus 1, a vehicle 2, and a user terminal 3, which are communicably connected to each other. FIG. 1 illustrates one of each of the control apparatus 1, the vehicle 2, and the user terminal 3, for convenience of explanation. However, the number of control apparatuses 1, the number of vehicles 2, and the number of user terminals 3 are not limited to one. The control apparatus 1, the vehicle 2, and the user terminal 3 are connected, for example, via a network NW which includes a mobile communication network and the Internet.

The control apparatus 1 may be a server that assists a provider in providing a vehicle dispatch service. The control apparatus 1 may be, for example, installed in a facility dedicated to a vehicle dispatch provider or in a shared facility including a data center. As an alternative example, the control apparatus 1 may be mounted in the vehicle 2.

The vehicle 2 is controlled by the control apparatus 1. The vehicle 2 includes, for example, any type of automobile such as a gasoline vehicle, a diesel vehicle, an HV, a PHV, an EV, or an FCV. The term “HV” is an abbreviation of Hybrid Vehicle. The term “PHV” is an abbreviation of Plug-in Hybrid Vehicle. The term “EV” is an abbreviation of Electric Vehicle. The term “FCV” is an abbreviation of Fuel Cell Vehicle. Although the driving of the vehicle 2 is automated at any level in the present embodiment, the vehicle 2 may be driven by a driver in another embodiment. The automation level is, for example, any one of Level 1 to Level 5 according to the level classifications defined by the SAE. The name “SAE” is an abbreviation of Society of Automotive Engineers. The vehicle 2 may be a MaaS-dedicated vehicle. The term “MaaS” is an abbreviation of Mobility as a Service.

The user terminal 3 is a terminal in the possession of a user. The user terminal 3 may be, for example, a mobile device including a mobile phone, a smartphone, or a tablet, or may be a PC. The term “PC” is an abbreviation of Personal Computer.

An outline of processing that is executed by the control apparatus 1 according to the present embodiment will be described. The control apparatus 1 controls the vehicle 2. The vehicle 2 stores baggage of a user who uses the user terminal 3, and delivers the baggage to the user in response to a request from the user terminal 3. The above configuration allows the vehicle 2 to transport the baggage on behalf of the user. Therefore, the control apparatus 1 can reduce the amount of baggage carried by the user while the user is moving. Thus, the control apparatus 1 can improve the ease of movement for the user.

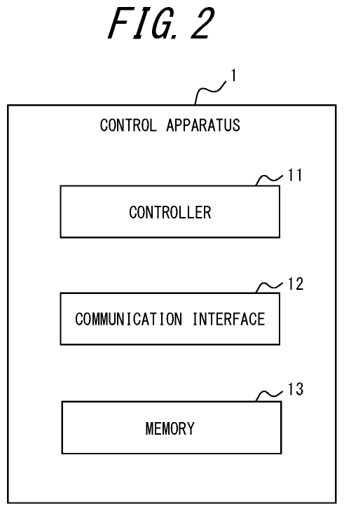

With reference to FIG. 2, an internal configuration of the control apparatus 1 will be described in detail.

The control apparatus 1 includes a controller 11, a communication interface 12, and a memory 13. The components of the control apparatus 1 are communicably connected to one another via, for example, a dedicated line.

The controller 11 includes, for example, one or more general-purpose processors including a Central Processing Unit (CPU) or a Micro Processing Unit (MPU). The controller 11 may include one or more dedicated processors that are dedicated to specific processing. The controller 11 may include one or more dedicated circuits instead of the processor. Examples of dedicated circuits may include a Field-Programmable Gate Array (FPGA) and an Application Specific Integrated Circuit (ASIC).

The communication interface 12 includes, for connecting to the network NW, one or more communication modules that conform to wired or wireless Local Area Network (LAN) standards. The communication interface 12 may include one or more modules conforming to mobile communication standards including the 4th Generation (4G) standard or the 5th Generation (5G) standard. The communication interface 12 may include one or more communication modules conforming to near field communication standards or specifications, including Bluetooth (Bluetooth is a registered trademark in Japan, other countries, or both), AirDrop (AirDrop is a registered trademark in Japan, other countries, or both), IrDA, ZigBee (ZigBee is a registered trademark in Japan, other countries, or both), Felica (Felica is a registered trademark in Japan, other countries, or both), or RFID. The communication interface 12 is configured to transmit and receive any appropriate information via the network NW. The any appropriate information includes, for example, positional information acquired through the Global Positioning System (GPS).

The memory 13 may be, but is not limited to, a semiconductor memory, a magnetic memory, or an optical memory. The memory 13 may function as, for example, a main memory, an auxiliary memory, or a cache memory. The memory 13 may store information resulting from analysis or processing performed by the controller 11. The memory 13 may store various types of information regarding operation and control of the control apparatus 1. The memory 13 may include a system program, an application program, embedded software, and the like. The memory 13 includes a baggage DB and a schedule DB. As an alternative example, the baggage DB and the schedule DB may be stored in a storage device external to the control apparatus 1.

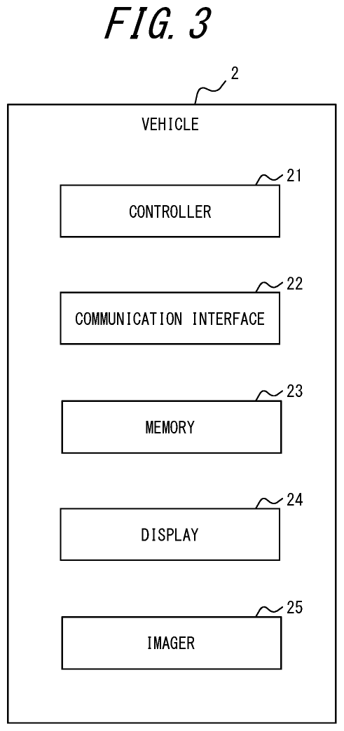

With reference to FIG. 3, an internal configuration of the vehicle 2 will be described in detail.

The vehicle 2 includes a controller 21, a communication interface 22, a memory 23, a display 24, and an imager 25. The components of the vehicle 2 are communicably connected to one another via, for example, a dedicated line. In the present embodiment, hardware components of the controller 21, the communication interface 22, and the memory 23 are the same as the hardware components of the controller 11, the communication interface 12, and the memory 13 of the control apparatus 1. Therefore, a description thereof is omitted here.

The display 24 is a display interface, and includes, for example, a panel display. The display 24 may display information read from the memory 23, an image captured by the imager 25, or information generated by the controller 21.

The imager 25 includes a camera and can capture an image of surroundings. The imager 25 may store the captured image in the memory 23 or transmit the captured image to the controller 21 for the purpose of analysis.

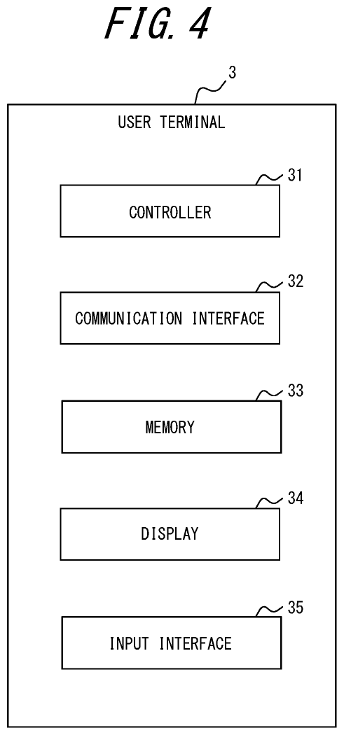

With reference to FIG. 4, an internal configuration of the user terminal 3 will be described in detail.

The user terminal 3 includes a controller 31, a communication interface 32, a memory 33, a display 34, and an input interface 35. The components of the user terminal 3 are communicably connected to one another, for example, via a dedicated line. In the present embodiment, the hardware components of the controller 31, the communication interface 32, the memory 33, and the display 34 are the same as the hardware components of the controller 21, the communication interface 22, the memory 23, and the display 24 of the vehicle 2. Therefore, a description thereof is omitted here.

The input interface 35 includes one or more input interfaces that detect a user input and send input information to the controller 31. Examples of input interfaces may include, but are not limited to, a physical key, a capacitive key, a touch screen integrally provided in the panel display, a microphone configured to receive audio input, and an IC card reader.

Hereinafter, processing executed in the information processing system S according to the present embodiment will be described in detail. Here, a scenario in which a user who uses the user terminal 3 departs for travel will be described as an example. A user ID of the user is U01.

The user packs baggage for travel. Upon completing packing, the user operates the input interface 35 of the user terminal 3 to request dispatch of the vehicle 2. This vehicle dispatch request includes positional information indicating a vehicle dispatch position, to which the vehicle is to be dispatched, that is designated by the user. Upon receiving the vehicle dispatch request, the user terminal 3 transmits the vehicle dispatch request to the control apparatus 1.

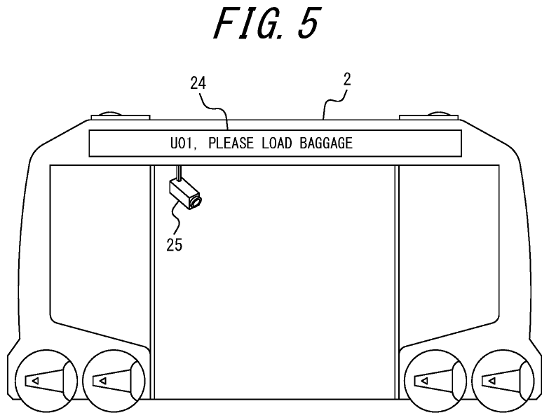

The control apparatus 1 dispatches the vehicle 2 to the vehicle dispatch position that was designated by the user. Upon arriving at the vehicle dispatch position, as illustrated in FIG. 5, the vehicle 2 opens a door and displays, on the display 24, an indication informing the user to load the baggage.

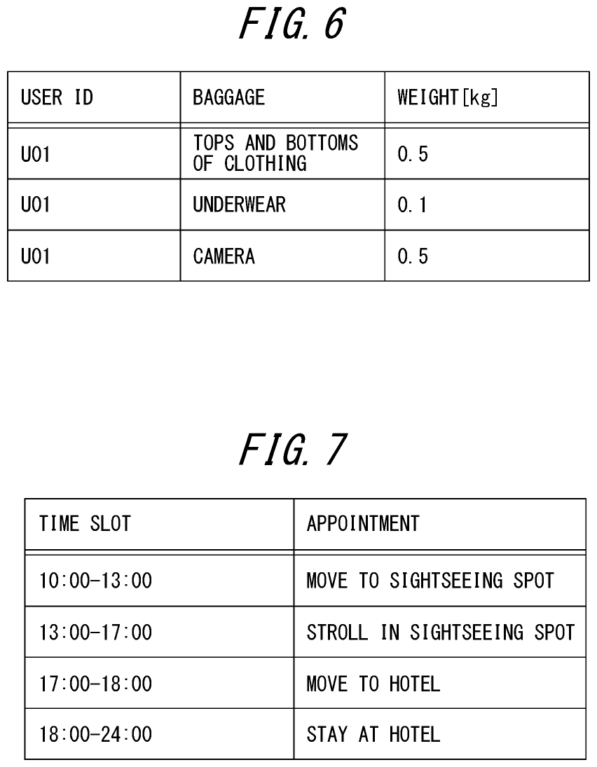

When receiving the baggage, the vehicle 2 may determine the content of the baggage. Specifically, the vehicle 2 requests the user, by voice audio or the like, to show the content of the baggage. The imager 25 of the vehicle 2 captures an image of the content of the baggage. The vehicle 2 transmits the captured image to the control apparatus 1 via the communication interface 22. The control apparatus 1 analyzes the captured image received, and identifies each item of baggage by shape, pattern, color, or the like. For analyzing the image, any appropriate method for analyzing the image, such as machine learning, can be used. As illustrated in FIG. 6, the control apparatus 1 stores, in a baggage DB in the memory 13, information on the baggage in association with the user ID (e.g., U01 herein) of the user who made the vehicle dispatch request. Additionally or alternatively, the control apparatus 1 may capture an image of the face of user U01 using the imager 25 to perform face recognition, and may store the information on the baggage in association with the recognition information.

When receiving baggage, the vehicle 2 may further measure the weight of each item of baggage using a weight scale that is provided in the vehicle 2. The vehicle 2 transmits a measured value of weight to the control apparatus 1. The control apparatus 1 stores, in the baggage DB, the measured value received in association with the information on the baggage.

The control apparatus 1 performs control to store the baggage of user U01 in the vehicle 2. Specifically, upon receiving the baggage from the user, the vehicle 2 stores the baggage in the vehicle 2 using a conveyor or a robotic arm. The baggage may be stored in a coin locker provided in the vehicle 2, or may be arranged on floors or shelves inside the vehicle 2.

The control apparatus 1 acquires, from a schedule DB in the memory 13, schedule information for the user. As illustrated in FIG. 7, the schedule information for the user includes information on time slots and appointments. The control apparatus 1 determines, from the schedule information, necessary items for which the probability of being required during the schedule is equal to or greater than a predetermined value. For example, if the control apparatus 1 identifies that the user is to stroll at a sightseeing spot between 13:00 and 17:00, the control apparatus 1 searches any appropriate databases for the probability of rainfall at the sightseeing spot for the time slot. If the control apparatus 1 determines, as a result of the search, that the probability of rainfall is equal to or more than the predetermined value, the control apparatus 1 determines that an umbrella is required. The predetermined value may be, for example, 50%. The control apparatus 1 refers to the baggage DB to determine whether the umbrella is included in the baggage. In the example of FIG. 6, the umbrella is not included in the baggage. The control apparatus 1 notifies the user, via the vehicle 2, that the umbrella is not included in the baggage, by voice audio or a visual representation.

Additionally or alternatively, the control apparatus 1 may store, in advance, a list of the necessary baggage in the memory 13. If the control apparatus 1 determines that the baggage of the user does not include the necessary baggage, the control apparatus 1 may notify the user of the necessary baggage via the vehicle 2, by voice audio or visual representation.

If the vehicle 2 refers to the schedule DB and determines the sightseeing spot where the user is to stroll, the vehicle 2 moves to the sightseeing spot. The vehicle 2 may move on a route that is separate from the user's route, or may move while keeping a substantially predetermined distance from the user. In a case in which the user uses an aircraft, upon arriving at an airport as a departure place, the vehicle 2 may check-in the baggage in a predetermined manner, and may put the baggage in the aircraft. At an airport as an arrival place, another vehicle 2 may be waiting to store the baggage of the user. As an alternative example, the vehicle 2 may move with the user on board.

If the control apparatus 1 receives, while user U01 is moving to the sightseeing spot to stroll, a vehicle dispatch request from one or more other users who are to visit the same sightseeing spot as user U01, the control apparatus 1 controls the vehicle 2 to store the baggage of the other users in the same manner as for user U01. When the baggage is stored in the vehicle 2, the control apparatus 1 stores, in the baggage DB in the memory 13, information on each item of baggage in association with each user ID of the other users.

The control apparatus 1 acquires the positional information for the user terminal 3, and determines whether the user terminal 3 has arrived at the sightseeing spot. If the control apparatus 1 determines that the user terminal 3 has arrived at the sightseeing spot, the control apparatus 1 determines, from the positional information for the user terminal 3, the travel route of the user up to the present point in time. The control apparatus 1 predicts the future travel route from the travel route of the user up to the present point in time. For example, the control apparatus 1 acquires information on a travel route of another user who moved on the same travel route as the travel route of the user up to the present point in time, and predicts, from the acquired information, the future travel route of the user.

The control apparatus 1 predicts the position where baggage is to be newly added and the amount of the baggage is to increase on the predicted future travel route. For example, if the control apparatus 1 detects, on the predicted future travel route, a shop (e.g., a souvenir shop) where an item can be purchased, the control apparatus 1 predicts that the purchased item is to be newly added as the baggage of the user at the shop. The control apparatus 1 controls the vehicle 2 to move to the position where the baggage is predicted to be newly added. Upon arriving at the predicted position, the vehicle 2 may notify the user terminal 3 that new baggage can be stored at the predicted position. Additionally or alternatively, upon arriving at the predicted position, the vehicle 2 may notify the user who has arrived, that new baggage can be stored, by voice audio or visual representation. In this way, the vehicle 2 can store the baggage while user U01 moves, in addition to when user U01 departs. That is, the vehicle 2 can store the baggage of the same user at different times.

When the new baggage of the user is stored in the vehicle 2, the control apparatus 1 determines whether the new baggage is an item that needs to be stored in a predetermined position other than the vehicle 2. For example, the control apparatus 1 performs image recognition on the captured image of the stored baggage, to determine whether the text “keep refrigerated”, “fragile”, “handle with care”, or similar text is printed on a surface of the item. If the control apparatus 1 determines that the text “keep refrigerated”, “fragile”, “handle with care”, or similar text is printed on the surface of the item, the control apparatus 1 may control the vehicle 2 to transport the item to a hotel or the like where the user is to stay for the night, in order to refrigerate the item.

As another function, upon acquiring the positional information for the user terminal 3, the control apparatus 1 determines a travel speed of the user terminal 3, from the transition of the positional information. If the travel speed does not exceed a predetermined value, the control apparatus 1 determines that the user is moving on foot. For example, the predetermined value may be 4 kilometers per hour.

Upon predicting the future travel route of the user in the above-described manner, the control apparatus 1 predicts the position where a degree of fatigue of the user will exceed a predetermined value on the future travel route. For example, the degree of fatigue of the user is determined according to the position on the travel route, and the degree of fatigue monotonously increases as a travel distance of the user increases. The position where the degree of fatigue of the user exceeds the predetermined value may be a position where a total value of a travel distance on foot exceeds a predetermined value. For example, the predetermined value may be 5 kilometers. As an alternative example, when the user is moving uphill, the position where the degree of fatigue of the user exceeds the predetermined value may be a position at which an altitude increase amount exceeds a predetermined value.

Upon arriving ahead of time at the position where the degree of fatigue of the user exceeds the predetermined value, the vehicle 2 may provide the user who has arrived at the position with any necessary baggage (e.g., a baby stroller, or a cold drink) that was stored when the user departed. Additionally or alternatively, upon arriving ahead of time at a position where the degree of fatigue of the user exceeds the predetermined value, the vehicle 2 may receive any baggage that has been carried by the user (e.g., an overcoat) from the user who has arrived at the position.

While moving to the hotel to stay for the night, the user operates the user terminal 3 to transmit a delivery request for the baggage. In the delivery request, a delivery location is designated by the user. At this time, a delivery date and time may be additionally designated. As an alternative example, the delivery request may be transmitted at any point in time. As another alternative example, the delivery location and the delivery date and time may be designated in the above-described vehicle dispatch request, which is transmitted when the user departs for the travel.

The control apparatus 1 controls delivery of the baggage to the user in response to the delivery request from the user terminal 3. Specifically, upon receiving the delivery request, the control apparatus 1 controls the vehicle 2 to move to the designated delivery location. A case in which the designated delivery location is a hotel where user U01 stays for the night will be described herein.

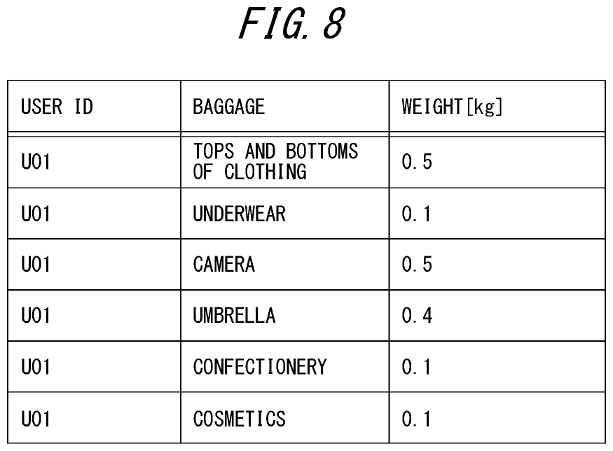

The control apparatus 1 refers to the baggage DB in the memory 13, and identifies the baggage associated with the same user (user U01 herein), as the baggage to be unloaded. As illustrated in FIG. 8, the baggage associated with user U01 are “tops and bottoms of clothing”, “underwear”, “camera”, “umbrella”, “confectionery”, and “cosmetics”. The control apparatus 1 calculates a total weight of this baggage. In the example of FIG. 8, the total weight is calculated as follows.

(Total weight)=0.5+0.1+0.5+0.4+0.1+0.1=1.7 kg

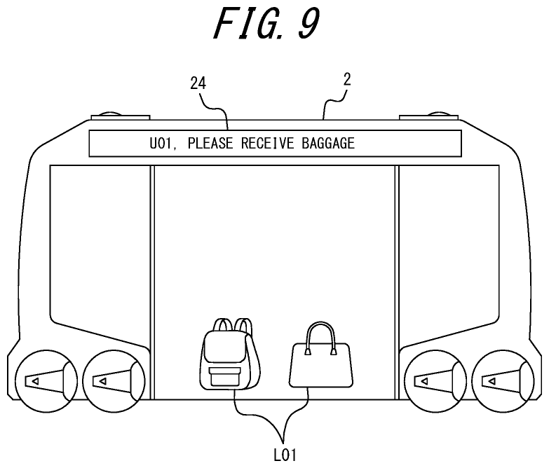

The vehicle 2 gathers, near the door, one or more items of baggage to be unloaded which are associated with user U01, using the conveyor or the robotic arm provided in the vehicle 2. As illustrated in FIG. 9, the vehicle 2 opens the door to present baggage L01 to be unloaded. The vehicle 2 displays, on the display 24, an indication informing the user to receive baggage L01.

The vehicle 2 totals the unloading weight of the one or more items of baggage to be unloaded. The control apparatus 1 determines whether the totaled unloading weight matches the total weight calculated above. If the unloading weight does not match the total weight, the conveyor or the robotic arm might have failed to move some of the baggage of the same user near to the door. If the control apparatus 1 determines that the unloading weight does not match the total weight, the control apparatus 1 notifies the user, via the vehicle 2, that there is a risk that not all of the baggage received from the same user has been unloaded, by voice audio or visual representation. As an alternative example, if the control apparatus 1 determines that the difference between the unloading weight and the total weight exceeds a predetermined value, the control apparatus 1 may notify the user, via the vehicle 2, that there is a risk that not all of the baggage received from the same user has been unloaded, by voice audio or visual representation.

As an alternative example, the baggage delivered by the vehicle 2 may be received by any member of staff of the hotel, rather than user U01, in response to a request from user U01. The baggage is transported into the hotel building. Check-in of the baggage is done by any member staff of the hotel.

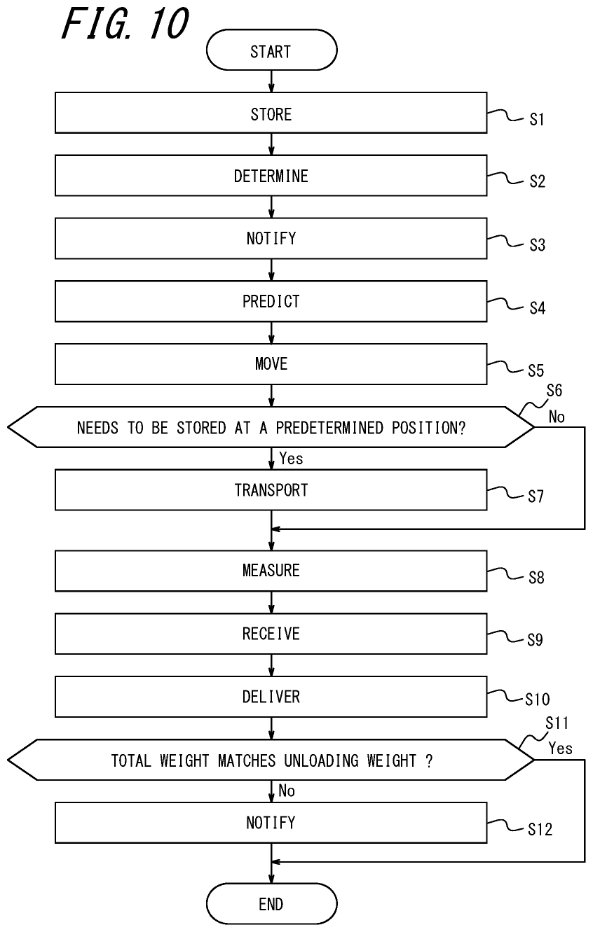

With reference to FIG. 10, a control method executed by the control apparatus 1 will be described.

In Step S1, the control apparatus 1 controls the vehicle 2 to store baggage of the user in the vehicle 2.

In Step S2, the control apparatus 1 determines content of the stored baggage, and acquires the schedule of the user. The control apparatus 1 determines a necessary item for which the probability of being required during the acquired schedule is equal to or greater than a predetermined value.

In Step S3, if the control apparatus 1 determines that a necessary item is not included in the content of the baggage, the control apparatus 1 may notify the user of the necessary item, via the vehicle 2, by voice audio or visual representation.

In Step S4, the control apparatus 1 acquires travel route information for the user, and predicts, from the travel route information, a position where the baggage of the user is to be newly added on the travel route. As an alternative example, the control apparatus 1 may predict a position where a degree of fatigue of the user exceeds a predetermined value.

In Step S5, the control apparatus 1 controls the vehicle 2 to move to the predicted position.

In Step S6, when the baggage of the user is stored in the vehicle 2, the control apparatus 1 determines whether the baggage is an item that needs to be stored at a predetermined position other than the vehicle 2.

If the result of the determination is “Yes” in Step S6, the control apparatus 1 controls, in Step S7, the vehicle 2 to transport the stored baggage to the predetermined position.

If the result of the determination is “No” in Step S6, the control apparatus 1 executes Step S8 without executing Step S7.

In Step S8, the control apparatus 1 measures a total weight of all of the baggage of the same user.

In Step S9, the control apparatus 1 receives a delivery request from the user terminal 3.

In Step S10, the control apparatus 1 controls, in response to the delivery request, the vehicle 2 to deliver the baggage of the user to the position designated by the user.

In Step S11, the control apparatus 1 controls the vehicle 2 to determine whether the total weight measured in Step S8 matches an unloading weight of all of the baggage to be unloaded.

If the result of the determination is “No” in Step S11, the control apparatus 1 notifies the user, in Step S12, via the vehicle 2, that the total weight does not match the unloading weight by voice audio or visual representation, to notify that there is a risk that not all of the baggage has been unloaded.

If the result of the determination is “Yes” in Step S11, the control apparatus 1 does not execute Step S12 and ends the processing flow.

As has been described, according to the present embodiment, a vehicle 2 stores baggage of a user of a user terminal 3, and delivers the baggage to the user in response to a request from the user terminal 3. The above configuration allows the vehicle 2 to transport the baggage on behalf of the user. Therefore, the control apparatus 1 can reduce the amount of baggage carried by the user while the user is moving. Thus, the control apparatus 1 can improve the ease of movement for the user, and increase the satisfaction of the user.

Moreover, according to the present embodiment, a controller 11 acquires travel route information for the user; predicts a future travel route from the travel route information; determines a degree of fatigue of the user according to a position on the predicted future travel route, and; performs control to move the vehicle 2 to a position at which the degree of fatigue exceeds a predetermined value. The position where the degree of fatigue exceeds the predetermined value may include a position at which a distance traveled by the user on foot exceeds a predetermined distance. The above configuration allows the vehicle 2 to arrive ahead of time at the position where the degree of fatigue of the user increases. Therefore, the vehicle 2 can receive the baggage carried by the user or can provide other necessary baggage. Thus, the control apparatus 1 can improve the ease of movement for the user.

Moreover, according to the present embodiment, a controller 11 acquires travel route information for the user; predicts a future travel route from the travel route information; predicts a position where baggage of the user is to be newly added on the predicted future travel route; and, performs control to move the vehicle 2 to the predicted position. The above configuration allows the control apparatus 1 to receive the newly added baggage. Therefore, the amount of baggage carried by the user can be reduced. Thus, the control apparatus 1 can improve ease of movement for the user.

Moreover, according to the present embodiment, the controller 11 determines, when performing control to store the baggage of the user, the content of the baggage, and acquires the schedule of the user to determine a necessary item for which the probability of being required during the acquired schedule is equal to or greater than a predetermined value. If the necessary item is not included in the content of the baggage, the controller 11 further notifies the user of the necessary item that is not included in the content of the baggage. The above configuration allows the controller 11 to prevent items from being left behind.

Moreover, according to the present embodiment, the control apparatus 1 performs control to store baggage of a plurality of users in the vehicle, and includes a memory 13 configured to store information on each item of baggage in association with each of the plurality of users. The above configuration allows the control apparatus 1 to associate, when receiving the baggage from a plurality of users, the information on each item of baggage with each of the users. Thus, the control apparatus 1 can reliably determine which user's baggage is being transported, and deliver each baggage to each owner.

Moreover, according to the present embodiment, the controller 11, upon determining that baggage stored in the vehicle 2 is an item that needs to be stored at a predetermined position other than the vehicle 2, performs control to transport the baggage stored in the vehicle 2 to a predetermined position. The above configuration allows the control apparatus 1 to temporary keep and transport the item to a position where the item can be stored, even in a case in which an item that cannot be stored in the vehicle 2 (e.g., an item that needs to be kept refrigerated or an item that is fragile) is stored. Thus, the control apparatus 1 can reduce spoilage of or damage to the item.

Moreover, according to the present embodiment, the controller 11 measures, upon storing baggage from a same user at different times, a total weight of all of the baggage of the same user, and measures an unloading weight of all of the baggage to be unloaded when the baggage is delivered to the same user. The controller 11 further determines whether the total weight matches the unloading weight. The above configuration allows the control apparatus 1 to prevent missed delivery of baggage that is received from the same user.

While the present disclosure has been described with reference to the drawings and examples, it is to be noted that various modifications and revisions may be implemented by those skilled in the art based on the present disclosure. Accordingly, such modifications and revisions are included within the scope of the present disclosure. For example, functions or the like included in each means or each step can be rearranged without logical inconsistency, and a plurality of means or steps can be combined together or divided.

For example, in the above embodiment, a program that executes all or some of the functions or processing of the control apparatus 1 may be recorded on a computer-readable recording medium. The computer-readable recording medium includes a non-transitory computer-readable medium and may be a magnetic recording apparatus, an optical disc, a magneto-optical recording medium, or a semiconductor memory. The program is distributed, for example, by selling, transferring, or lending a portable recording medium such as a Digital Versatile Disc (DVD) or a Compact Disc Read Only Memory (CD-ROM) on which the program is recorded. The program may also be distributed by storing the program in a storage of the server and transmitting the program from the server to another computer. The program may also be provided as a program product. The present disclosure may also be implemented as a program that can be executed by a processor.

1. A control apparatus for controlling a vehicle that is communicably connected to a user terminal, the control apparatus comprising a controller, wherein the controller is configured to:
perform control to store, in the vehicle, baggage of a user of the user terminal; and
perform control to deliver the baggage to the user in response to a request from the user terminal.

2. The control apparatus according to claim 1, wherein the controller is configured to:
acquire travel route information for the user;
predict a future travel route from the travel route information;
determine a degree of fatigue of the user according to a position on the predicted future travel route; and
perform control to move the vehicle to a position at which the degree of fatigue exceeds a predetermined value.

3. The control apparatus according to claim 2, wherein the position at which the degree of fatigue exceeds the predetermined value includes a position at which a distance traveled by the user on foot exceeds a predetermined distance.

4. The control apparatus according to claim 1, wherein the controller is configured to:
acquire travel route information for the user;
predict a future travel route from the travel route information;
predict a position where baggage of the user is to be newly added on the predicted future travel route; and
perform control to move the vehicle to the predicted position.

5. The control apparatus according to claim 1, wherein the controller is configured to:
when performing control to store the baggage of the user, determine content of the baggage and acquire a schedule of the user to determine a necessary item for which a probability of being required during the acquired schedule is equal to or greater than a predetermined value; and
if the necessary item is not included in the content of the baggage, notify the user of the necessary item that is not included in the content of the baggage.

6. The control apparatus according to claim 1, wherein the controller is configured to perform control to store baggage of a plurality of users in the vehicle, the control apparatus further comprising a memory configured to store information on each baggage in association with each of the plurality of users.

7. The control apparatus according to claim 1, wherein the controller, upon determining that baggage stored in the vehicle is an item that needs to be stored at a predetermined position other than the vehicle, performs control to transport the baggage stored in the vehicle to the predetermined position.

8. The control apparatus according to claim 1, wherein the controller is configured to:
measure, upon storing baggage from a same user at different times, a total weight of all of the baggage of the same user, and measure an unloading weight of all baggage to be unloaded when the baggage is delivered to the same user; and
determine whether the total weight matches the unloading weight.

9. A vehicle equipped with the control apparatus according to claim 1.

10. A non-transitory computer readable medium storing a program configured to cause a computer, as a control apparatus for controlling a vehicle that is communicably connected to a user terminal, to execute:
control to store, in the vehicle, baggage of a user of the user terminal; and
control to deliver the baggage to the user in response to a request from the user terminal.

11. The non-transitory computer-readable medium according to claim 10, wherein the program is configured to further cause the computer to:
acquire travel route information for the user;
predict a future travel route from the travel route information;
determine a degree of fatigue of the user according to a position on the predicted future travel route; and
perform control to move the vehicle to a position where the degree of fatigue exceeds a predetermined value.

12. The non-transitory computer-readable medium according to claim 11, wherein the position at which the degree of fatigue exceeds the predetermined value includes a position at which a distance traveled by the user on foot exceeds a predetermined distance.

13. The non-transitory computer-readable medium according to claim 10, wherein the program is configured to further cause the computer to:
acquire travel route information for the user;
predict a future travel route from the travel route information;
predict a position where baggage of the user is to be newly added on the predicted future travel route; and
perform control to move the vehicle to the predicted position.

14. The non-transitory computer-readable medium according to claim 10, wherein the program is configured to further cause the computer to:
when performing control to store the baggage of the user, determine content of the baggage and acquire a schedule of the user to determine a necessary item for which a probability of being required during the acquired schedule is equal to or greater than a predetermined value; and
if the necessary item is not included in the content of the baggage, notify the user of the necessary item that is not included in the content of the baggage.

15. The non-transitory computer-readable medium according to claim 10, wherein the program is configured to further cause the computer to:
upon determining that baggage stored in the vehicle is an item that needs to be stored at a predetermined position other than the vehicle, perform control to transport the baggage stored in the vehicle to the predetermined position.

16. A control method performed by a control apparatus for controlling a vehicle that is communicably connected to a user terminal, the control method comprising:
performing control to store, in the vehicle, baggage of a user of the user terminal; and
performing control to deliver the baggage to the user in response to a request from the user terminal.

17. The control method according to claim 16, further comprising:
acquiring travel route information for the user;
predicting a future travel route from the travel route information;
determining a degree of fatigue of the user according to a position on the predicted future travel route; and
performing control to move the vehicle to a position at which the degree of fatigue exceeds a predetermined value.

18. The control method according to claim 17, wherein the position at which the degree of fatigue exceeds the predetermined value includes a position at which a distance traveled by the user on foot exceeds a predetermined distance.

19. The control method according to claim 16, further comprising:
acquiring travel route information for the user;
predicting a future travel route from the travel route information;
predicting a position where baggage of the user is to be newly added on the predicted future travel route; and
performing control to move the vehicle to the predicted position.

20. The control method according to claim 16, further comprising:
when performing control to store the baggage of the user, determining content of the baggage, and acquiring a schedule of the user to determine a necessary item for which a probability of being required during the acquired schedule is equal to or greater than a predetermined value; and
if the necessary item is not included in the content of the baggage, notifying the user of the necessary item that is not included in the content of the baggage.
